(19) United States
(12) Patent Application Publication
(10) Pub. No.: US 2009/0115720 A1
(43) Pub. Date: May 7, 2009

(54) Liquid crystal display, liquid crystal display module, and method of driving liquid crystal display

(75) Inventors: Tetsuji Inada, Kanagawa (JP); Mitsuyasu Asano, Tokyo (JP); Ichiro Murakami, Tokyo (JP); Norimasa Furukawa, Tokyo (JP); Yoshihiro Katsu, Kanagawa (JP); Takeshi Hiramatsu, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/289,369

(22) Filed: Oct. 27, 2008

(30) Foreign Application Priority Data
Nov. 6, 2007 (JP) 2007-288432

(51) Int. Cl. G09G 3/36

(52) U.S. Cl. 345/102

(57) ABSTRACT

A liquid crystal display includes: a light source section including a plurality of lighting sections; a light source driving section for determining a light intensity of each lighting section according to the image signal inputted and driving the light source section so that each lighting section is independently activated with the light intensity determined; a liquid crystal display panel; and a display driving section for driving the liquid crystal display panel based on the image signal. In a case that a display region corresponding to the lighting section includes a high-luminance part and a low-luminance part, the display driving section corrects the image signal in the low-luminance part so that the display luminance of the low-luminance part results in the same level as the display luminance under a maximum light intensity of the corresponding lighting section, and drives the low-luminance part according to the image signal corrected.

### CROSS REFERENCES TO RELATED APPLICATIONS

The present invention contains subject matter related to Japanese Patent Application JP2007-288432 filed in the Japanese Patent Office on Nov. 6, 2007 the entire contents of which being incorporated herein by reference.

### BACKGROUND OF THE INVENTION

1. Field of the Invention

The present invention relates to a liquid crystal display using a light source device which has a plurality of partial lighting sections independently controllable to one another, a method of driving the liquid crystal display, and a liquid crystal display module applied to such a liquid crystal display.

2. Description of the Related Art

In recent years, there is a trend toward thinning of displays as typified by liquid crystal display TVs and plasma display panels (PDP). In particular, displays for mobile use employ liquid crystal displays in most cases, and faithful color-reproduction is desired. Although CCFLs (cold cathode fluorescent lamp) using fluorescent tubes are mainstream as backlights of liquid crystal display panels, there has been a demand for mercury-free light sources due to ecological issues. As light sources replacing CCFLs, light emitting diodes (LED) and the like have been regarded as promising.

For example, in Japanese Unexamined Patent Publication No. 2001-142409, proposed is a backlight device using such LEDs. In this LED backlight device, a light source section includes a plurality of separate partial lighting sections, and each partial lighting section independently performs the lighting operation as a unit. Due to such respective lighting operations in the light source section, the display may be lighted by lighting only a necessary partial lighting section, and this beneficially leads to low electrical power consumption and contrast improvement.

### SUMMARY OF THE INVENTION

However, because a lighting region of each partial lighting section in the light source section is generally larger than each pixel in a liquid crystal display panel, for example, in the case where it is desired that only a few pixels in a low-luminance part in a partial display region corresponding to the partial lighting section is brightly displayed, a so-called “flare phenomenon” (a phenomenon in which something like flare appears, and the same is true, hereinafter) occurs. That is, in the partial display region, although the light from the corresponding partial lighting section is emitted to the low-luminance part, it is difficult that the transmissivity of the liquid crystal display panel becomes “0%” completely, due to features of the liquid crystal. Thus, light leakage in the low-luminance part occurs, and the display becomes as black color is partially too strong. Therefore, when comparing between the partial display region which partially includes a high-luminance part in the low-luminance part, and the partial display region which is the low-luminance part overall, even if the luminance level of the image signal in the low-luminance part of the former partial display region is equal to the luminance level of the image signal in the low-luminance part of the latter partial display region, the display luminances of these low-luminance parts become different from each other, and variations of the black displays are visible. When the variations of such display luminances occur, the image quality of the display image is lowered.

In view of the foregoing, it is desirable to provide a liquid crystal display capable of improving image quality of a display image and a method of driving the liquid crystal display when performing partial lighting operations by a light source section, and a liquid crystal display module applied to such a liquid crystal display.

According to an embodiment of the present invention, there is provided a liquid crystal display including a signal input section through which an image signal from external is inputted, a light source section including a plurality of partial lighting sections to be controlled independently of one another, a light source driving means for determining a light intensity of each partial lighting section according to the image signal inputted from the signal input section, and driving the light source section so that each partial lighting section is independently activated with the light intensity determined, a liquid crystal display panel including a plurality of pixels which are arranged in a matrix form, and displaying an image by modulating light emitted from the light source section for each pixel, and a display driving means for driving the liquid crystal display panel based on the image signal inputted through the signal input section. In a case that a partial display region corresponding to a partial lighting section includes a high-luminance part with a luminance level higher than a luminance threshold and a low-luminance part with a luminance level lower than the luminance threshold, the low-luminance part surrounding the high-luminance part, the display driving means corrects the image signal in the low-luminance part so that the display luminance level in the low-luminance part results in the same level as the display luminance level under a maximum light intensity of the corresponding partial lighting section, and drives pixels in the low-luminance part according to the image signal corrected.

According to an embodiment of the present invention, there is provided a first liquid crystal display module applied to the liquid crystal display including the light source section, the light source drive means, the liquid crystal display panel, and the display driving means.

According to an embodiment of the present invention, there is provided a second liquid crystal display module applied to the liquid crystal display including the light source section includes the light source driving means, the liquid crystal display panel, and the display driving means.

According to an embodiment of the present invention, there is provided a method of driving a liquid crystal display including the light source section and the liquid crystal display panel. In a case that a partial display region corresponding to a partial lighting section includes a high-luminance part with a luminance level higher than a luminance threshold and a low-luminance part with a luminance level lower than the luminance threshold, the low-luminance part surrounding the high-luminance part, the image signal in the low-luminance part is corrected so that the display luminance level in the low-luminance part results in the same level as the display luminance level under a maximum light intensity of the corresponding partial lighting section, and pixels in the low-luminance part are driven according to the image signal corrected.

In the liquid crystal display, the liquid crystal display module, and the method of driving the liquid crystal display according to an embodiment of the present invention, the light intensity of each partial lighting section is determined according to the inputted image signal and the light source section is driven so that each partial lighting section is independently activated with the light intensity determined. An image is displayed on the liquid crystal display panel by modulating light emitted from the light source section for each pixel. Moreover, in a case that a partial display region corresponding to a partial lighting section includes a high-luminance part with a luminance level higher than a luminance threshold and a low-luminance part with a luminance level lower than the luminance threshold, the low-luminance part surrounding the high-luminance part, the display driving means corrects the image signal in the low-luminance part so that the display luminance level in the low-luminance part results in the same level as the display luminance level under a maximum light intensity of the corresponding partial lighting section, and drives pixels in the low-luminance part according to the image signal corrected. Therefore, when comparing between the partial display region which partially the high-luminance part, and the partial display region which is the low-luminance part overall, if the luminance level of the image signal in the low-luminance part of the former partial display region is approximately equal to the luminance level of the image signal in the low-luminance part in the latter partial display region, the display luminances of these low-luminance parts are approximately equal to each other. Thereby, generation of the flare phenomenon is suppressed or prevented, and the variations of the display luminances are suppressed.

According to the liquid crystal display, the liquid crystal display module, and the method of driving the liquid crystal display in an embodiment of the present invention, in a case that a partial display region corresponding to a partial lighting section includes a high-luminance part with a luminance level higher than a luminance threshold and a low-luminance part with a luminance level lower than the luminance threshold, the low-luminance part surrounding the high-luminance part, the display driving means corrects the image signal in the low-luminance part so that the display luminance level in the low-luminance part results in the same level as the display luminance level under a maximum light intensity of the corresponding partial lighting section, and drives pixels in the low-luminance part according to the image signal corrected. Thus, the variations of the display luminances in the low-luminance parts are suppressed. Therefore, the image quality of the display image may be improved at the time of the lighting operation by the light source section.

Other and further objects, features and advantages of the invention will appear more fully from the following description.

### BRIEF DESCRIPTION OF THE DRAWINGS

FIG. 1 is an exploded perspective view illustrating the configuration of a main part of a liquid crystal display according to an embodiment of the present invention.

FIGS. 2A and 2B are schematic plan views illustrating a configuration example of a unit (partial lighting section) of a light source section in a backlight system shown in FIG. 1.

FIG. 3 is a schematic plan view illustrating a layout configuration example of the partial lighting section and an illumination light sensor in the light source section, and a detection range of each illumination light sensor in FIGS. 2A and 2B.

FIG. 4 is a block diagram illustrating the overall configuration of the liquid crystal display shown in FIG. 1.

FIG. 5 is a block diagram illustrating the detailed configuration of a drive section and a control section of the light source section shown in FIG. 4.

FIG. 6 is a block diagram illustrating the detailed configuration of a flare correcting section shown in FIG. 4.

FIG. 7 is a timing waveform diagram for explaining a drive pulse signal of the light source section.

FIG. 8 is a timing waveform diagram for explaining an example of a method of driving a liquid crystal display panel and the backlight system shown in FIG. 1.

FIG. 9 is a characteristic view illustrating an example of relationship between a luminance level of an input image signal and transmissivity (a display luminance) of the liquid crystal.

FIGS. 10A to 10C are characteristic views, each illustrating an example of relationship between the luminance level of the input image signal according to a set luminance (a light source luminance) in the backlight system and the transmissivity (the display luminance) of the liquid crystal.

FIG. 11 is a block diagram illustrating the overall configuration of a liquid crystal display according to a comparative example.

FIG. 12 is a characteristic view for explaining generation of flare phenomenon in the comparative example.

FIG. 13 is a characteristic view for explaining generation of the flare phenomenon in the comparative example.

FIG. 14 is a characteristic view for explaining a concept of the correction of the image signal in a low-luminance part according to the embodiment.

FIG. 15A is a characteristic view for explaining control of the flare phenomenon in the embodiment.

FIG. 16 is a characteristic view for explaining detail of the correction of the image signal in the low-luminance part according to the embodiment.

FIG. 17 is a characteristic view for explaining detail of the correction of the image signal in the low-luminance part in a first luminance range shown in FIG. 16.

FIG. 18 is a characteristic view for explaining detail of the correction of the image signal in the low-luminance part in a second luminance range shown in FIG. 16.

FIG. 19 is a block diagram illustrating the overall configuration of a liquid crystal display according to a modification of the present invention.

FIG. 20 is a block diagram illustrating the detailed configuration of a drive section and a control section of a light source section shown in FIG. 19.

FIG. 21 is a block diagram illustrating the detailed configuration of a flare correcting section shown in FIG. 19.

FIG. 22 is a characteristic view illustrating an example of a luminance histogram distribution formed in a switching control section shown in FIG. 19.

FIG. 23 is a view for explaining an example of switching control using the luminance histogram distribution shown in FIG. 22.

FIG. 24 is a characteristic view for explaining control of flare phenomenon in the modification.

### DETAILED DESCRIPTION OF THE PREFERRED EMBODIMENTS

Preferred embodiments of the present invention will be described in detail with reference to the accompanying drawings.

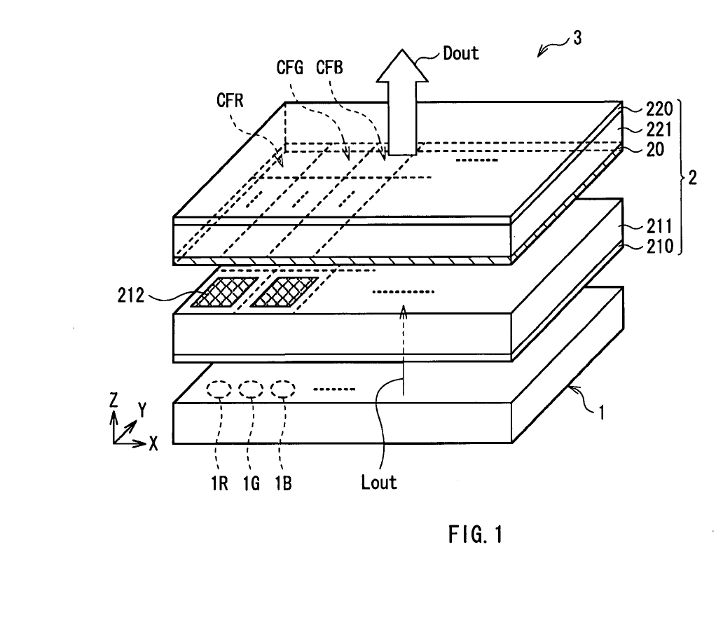

FIG. 1 is an exploded perspective view schematically showing the configuration of a main part of a liquid crystal display (a liquid crystal display 3) according to an embodiment of the present invention. The liquid crystal display 3 is a so-called transmissive liquid crystal display emitting a transmitted light as a display light Dout, and includes a backlight system 1 and a transmissive liquid crystal display panel 2. A liquid crystal display module according to an embodiment of the present invention, and a method of driving the liquid crystal display according to an embodiment of the present invention are realized by the liquid crystal display of the present embodiment, and thus they will also be described in addition.

The liquid crystal display panel 2 includes a transmissive liquid crystal layer 20, a pair of substrates with the liquid crystal layer 20 in between, that is, a TFT (thin film transistor) substrate 211 which is located closer to the backlight system 1 and a facing electrode substrate 221 which faces the TFT substrate 211, and polarizing plates 210 and 220 which are stacked on the opposite side of the TFT substrate 211 from the liquid crystal layer 20, and on the opposite side of the facing electrode substrate 221 from the liquid crystal layer 20, respectively.

The TFT substrate 211 includes pixels arranged in a matrix form, and, in each pixel, a pixel electrode 212 including a drive element such as a TFT is formed.

The backlight system 1 is an additive-color-mixing backlight system obtaining a illumination light Lout as a specific color light (in this case, a white light) by mixing a plurality of color lights (in this case, a red light, a green light and a blue light), and includes a light source section (a light source section 10 which will be described later) including a plurality of red LEDs 1R, a plurality of green LEDs 1G, and a plurality of blue LEDs 1B.

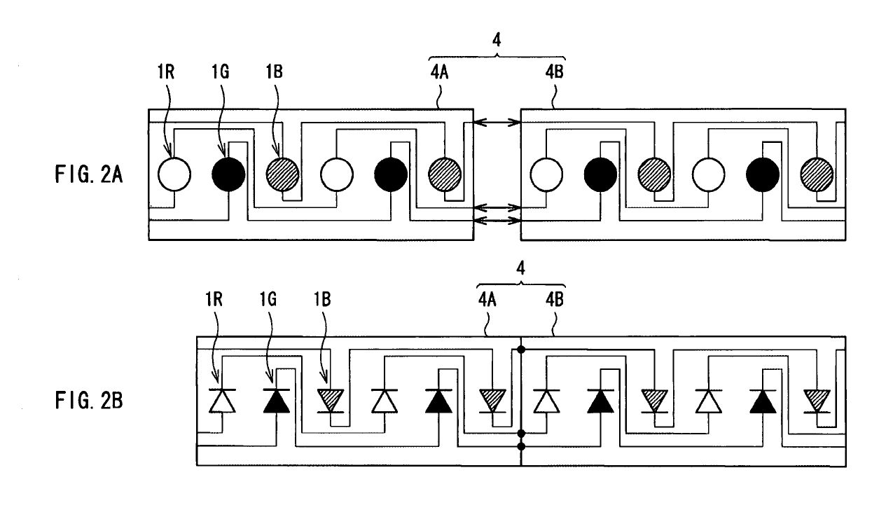

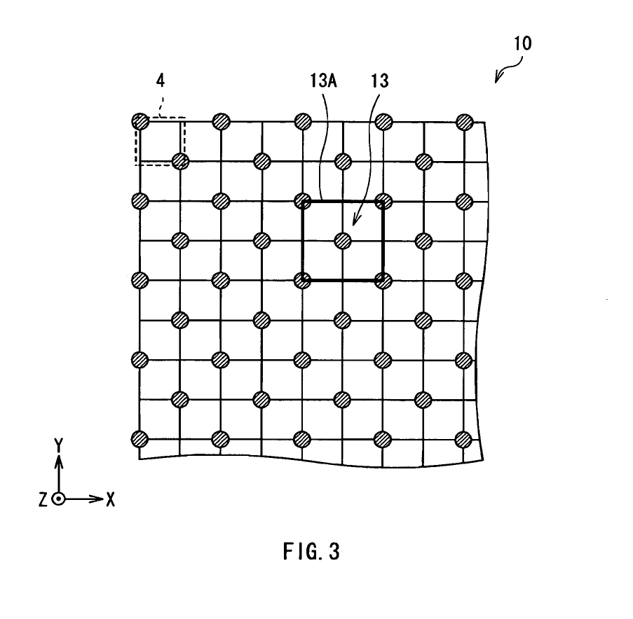

FIGS. 2A, 2B and 3 are plan views (X-Y plan views), each showing an example of arrangement of LEDs of each color in the backlight system 1.

As shown in FIG. 2A, in the backlight system 1, unit cells 4A and 4B of a light emitting section are formed by two sets of the red LED 1R, the green LED 1G, and the blue LED 1B, respectively, and the two unit cells 4A and 4B constitute a partial lighting section 4 as a unit of the light emitting section. Moreover, in each of the unit cells 4A and 4B, and between the unit cells 4A and 4B, LEDs of each color are connected in series to one another. Specifically, as shown in FIG. 2B, an anode of a LED of each color is connected to a cathode of another LED of the same color.

For example, as shown in FIG. 3, the partial lighting sections 4 having such a configuration are arranged in a matrix form in the light source section 10. The partial lighting sections 4 are controllable independently of one another as will be described later. On the light source section 10, an illumination light sensor 13 is disposed over a corner of a partial lighting section 4 and a corner of an adjacent partial lighting section 4 along an X axis and a Y axis. There are such arrangement patterns alternately extending in sequence along the X axis and the Y axis. The illumination light sensor 13 obtains a light-receiving signal by receiving the illumination light Lout from the light source section 10 in which each partial lighting section 4 performs lighting as a unit.

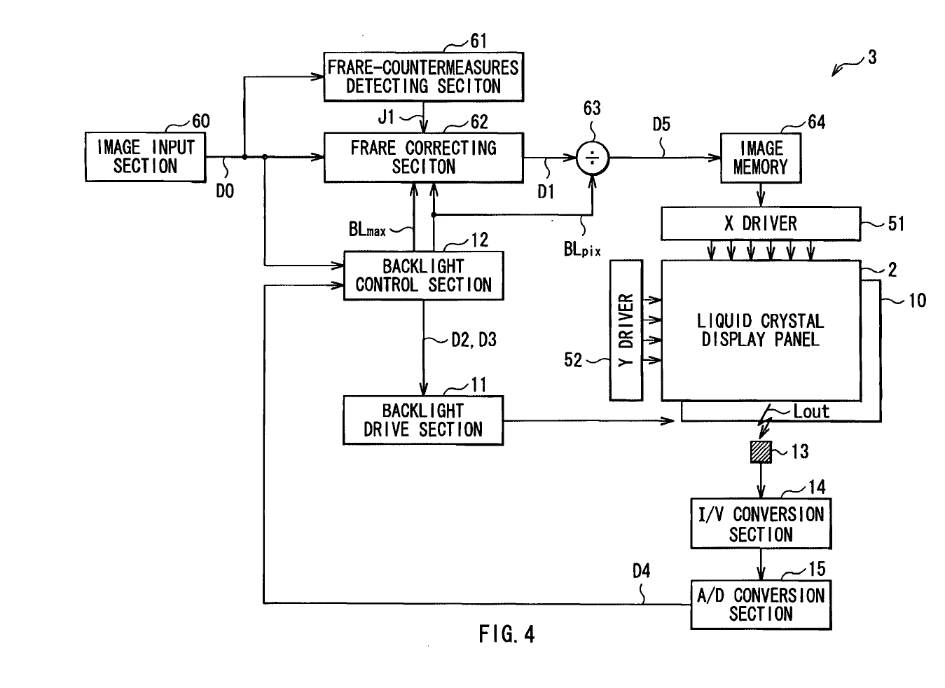

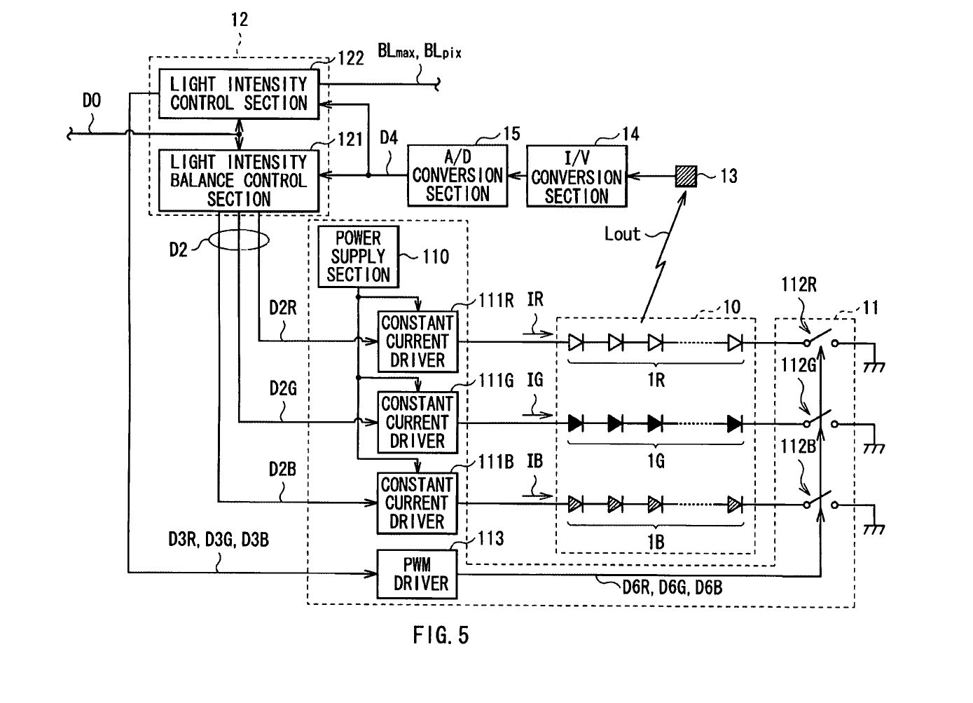

Next, with reference to FIG. 4, the configurations of drive sections and control sections of the liquid crystal display panel 2 and the light source section 10 will be described in detail. FIG. 4 shows a block diagram of the liquid crystal display 3. In addition, it is assumed that only a single illumination light sensor 13 is disposed in the vicinity of the light source section 10 in FIG. 4 (and FIG. 5 which will be described later) for convenience sake.

As shown in FIG. 4, a drive circuit for driving the liquid crystal display panel 2 so as to display an image includes an X driver (a data driver) 51 supplying a drive voltage to each pixel electrode 212 in the liquid crystal display panel 2, on the basis of an image signal, a Y driver (a gate driver) 52 line-sequentially driving each pixel electrode 212 in the liquid crystal display panel 2 along a scanning line which is not shown in the figure, an image signal input section 60, a flare-countermeasures determining section 61 for suppressing generation of flare phenomenon which will be described later, a flare correcting section 62 and a dividing section 63, and an image memory 64 as a frame memory storing an image signal to be supplied to the X driver 51.

The image signal input section 60 inputs an external image signal, and performs a predetermined image process (for example, white balance adjustment process and RGB process) to the inputted image signal, thereby outputting an image signal D0 as an RGB signal. The image signal input section 60 includes, for example, a TV tuner, an external input section, and the like.

The flare-countermeasures determining section 61 determines, on the basis of the image signal D0 supplied from the image signal input section 60, whether or not there is a risk of generation of a so-called “flare phenomenon” in each partial display region (for example, display regions 41 to 43 which will be described later) corresponding to each partial lighting section 4. Specifically, the flare-countermeasures determining section 61 determines whether or not a predetermined condition is satisfied such that the partial display region corresponding to the partial lighting section 4 includes a low-luminance part in the periphery of a high-luminance part, the low-luminance part being a display part having a luminance level lower than a predetermined luminance threshold (for example, a luminance threshold P which will be described later), and a high-luminance part being a display part having a luminance level higher than the luminance threshold. The flare-countermeasures determining section 61 outputs a determined result (a flare-countermeasures determined result J1) to the flare correcting section 62. In addition, when the flare-countermeasures determining section 61 determines whether or not such a condition is satisfied, for example, it is possible to determine it by considering whether or not there is extensity of the low-luminance part in the periphery of the high-luminance part in each partial display region. In this case, for example, an area, histogram, and the like are used for the determination.

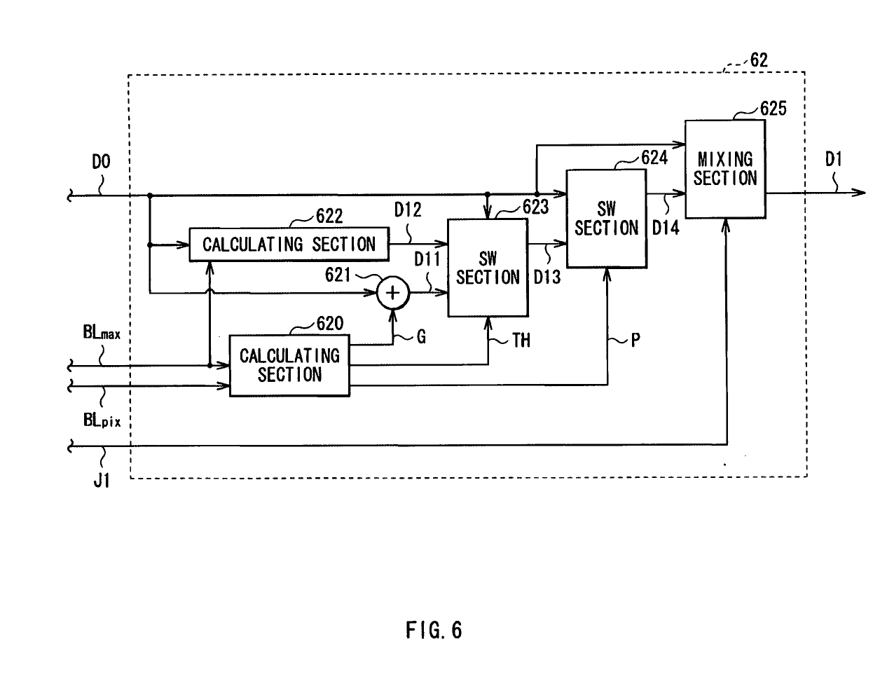

On the basis of the flare-countermeasures determined result J1 supplied from the flare-countermeasures determining section 61, in the case where it is determined that the above-mentioned predetermined condition is satisfied (when it is determined that there is a risk of generation of the flare phenomenon), the flare correcting section 62 corrects the image signal D0 in the low-luminance part as follows. On a condition that the partial lighting section 4 corresponding to the partial display region satisfying the above-mentioned condition has a light intensity (a set luminance BLpix) determined by a backlight control section 12 which will be described later, the correction of the image signal D0 in the low-luminance part is performed so that the display luminance level (the intensity of the display light Dout emitted from the liquid crystal display panel 2) of the low-luminance part of the partial display region results in approximately equal to the display luminance level under a maximum light intensity (a maximum illumination BLmax which is not only the fixed maximum value of the device (each partial lighting section 4) itself, but also the maximum value which is variable according to the image signal D0) of the partial lighting section 4 corresponding to the partial display region. Then, the corrected image signal D1 is supplied to the dividing section 63. In addition, in the case where it is determined that the above-mentioned predetermined condition is not satisfied (when it is determined that there is no risk of generation of the flare phenomenon) on the basis of the flare-countermeasures determined result J1, the inputted image signal D0 is just outputted as the image signal D1. The detail will be described later. Also, the detailed configuration of the flare correcting section 62 will be described later (FIG. 6).

As shown in equation (1) below, the dividing section 63 divides the image signal D1 supplied from the flare correcting section 62 by the set luminance BLpix of each partial lighting section 4 supplied from the backlight control section 12 so as to generate an image signal D5, and supplies the image signal D5 to the image memory 64. Thereby, the display may be driven in consideration with a light intensity distribution of the light emitted from each partial lighting section 4. The detail will be described later.

D5=D1/BLpix (1)

The image memory 64 stores the image signal D5 supplied from the dividing section 63, by only pixels in one frame (one screen) of the liquid crystal display panel 2, and is composed of, for example, SRAM (static random access memory), and the like.

The sections for driving and controlling the lighting operation of the light source section 10 in the backlight system 1 are a backlight drive section 11, a backlight control section 12, the above-mentioned illumination light sensor 13, an I/V conversion section 14, and an A/D conversion section 15.

The I/V conversion section 14 performs I/V (current/voltage) conversion on a light-receiving signal obtained in the illumination light sensor 13, thereby outputting a light-receiving data, which is an analogue voltage signal.

The A/D conversion section 15 samples the light-receiving data outputted from the I/V conversion section 14 at a predetermined timing, and performs A/D (analogue/digital) conversion, thereby outputting a light-receiving data D4, which is a digital voltage signal, to the backlight control section 12.

The backlight control section 12 sets the light intensity of each partial lighting section 4, on the basis of the light-receiving data D4 supplied from the A/D conversion section 15 and the image signal D0 supplied from the image signal input section 60, thereby generating and outputting a control signal D2 (control signals D2R, D2G, and D2B which will be described later) and a control signal D3 (control signals D3R, D3G, and D3B which will be described later). Thus, the backlight control section 12 controls the drive operation of the backlight drive section 11. The detailed configuration of the backlight control section 12 will be described later (FIG. 5).

The backlight drive section 11 drives, on the basis of the control signals D2 and D3 supplied from the backlight control section 12, the light source section 10 so that each partial lighting section 4 independently performs the lighting operation with the light intensity set by the backlight control section 12. The detailed configuration of the backlight drive section 11 will be described later (FIG. 5).

Next, with reference to FIG. 5, the detailed configurations of the above-mentioned backlight drive section 11 and the backlight control section 12 will be described. FIG. 5 is a block diagram illustrating the detailed configurations of the backlight drive section 11 and the backlight control section 12, as well as the configurations of the light source section 10, the illumination light sensor 13, the I/V conversion section 14, and the A/D conversion section 15. The control signal D2 includes the control signal for red D2R, the control signal for green D2G, and the control signal for blue D2B. The control signal D3 includes the control signal for red D3R, the control signal for green D3G, and the control signal for blue D3B. A control signal D6 includes a control signal for red D6R, a control signal for green D6G, and a control signal for blue D6B. Here, it is assumed that all of the red LEDs 1R, the green LEDs 1G and the blue LEDs 1B in the light source section 10 are connected in series to one another for convenience sake.

The backlight drive section 11 includes a power supply section 110, constant current drivers 111R, 111G, and 111B, switching elements 112R, 112G, and 112B, and a PWM driver 113. The constant current drivers 111R, 111G, and 111B supply, on the basis of the control signal D2 (the control signal for red D2R, the control signal for green D2G, and the control signal for blue D2B) supplied from the backlight control section 12, currents IR, IG, and IB to anodes of the red LED 1R, the green LED 1G, and the blue LED 1B in the light source section 10 with voltage supplied from the power supply section 110. The switching elements 112R, 112G, and 112B are connected between cathodes of the red LED 1R, the green LED 1G, and the blue LED 1B and grounds of these LEDs, respectively. The PWM driver 113 generates and outputs, on the basis of the control signal D3 (the control signal for red D3R, the control signal for green D3G, and the control signal for blue D3B) supplied from the backlight control section 12, the control signal D6 (pulse signals: the control signal for red D6R, the control signal for green D6G, and the control signal for green D6B) which is for the switching elements 112R, 112G, and 112B, and controls the switching elements 112R, 112G, and 112B in PWM mode.

The backlight control section 12 includes a light intensity balance control section 121, and a light intensity control section 122. On the basis of the light-receiving data D4 supplied from the A/D conversion section 15 and the image signal D0 supplied from the image signal input section 60, the light intensity balance control section 121 generates and outputs the control signal D2 (the control signal for red D2R, the control signal for green D2G, and the control signal for blue D2B) which is for controlling the constant current drivers 111R, 1G, and 111B, respectively, thereby controlling and changing the light intensity of the illumination light Lout while the color balance (white balance of a white light) of the illumination light Lout from the light source section 10 is maintained constant. On the basis of the light-receiving data D4 supplied from the A/D conversion section 15 and the image signal D0 supplied from the image signal input section 60, the light intensity control section 122 generates and outputs the control signal D3 (the control signal for red D3R, the control signal for green D3G, and the control signal for blue D3B) which is for controlling the PWM driver 113, thereby controlling and changing the light intensity of the illumination light Lout from the light source section 10.

Next, with reference to FIG. 6, the detailed configuration of the above-mentioned flare correcting section 62 will be described. FIG. 6 illustrates the block diagram of the flare correcting section 62.

The flare correcting section 62 includes calculating sections 620 and 622, an adding section 621, switching (SW) sections 623 and 624, and a mixing section 625.

On the basis of the set luminance BLpix and the maximum luminance BLmax of each partial lighting section 4, the calculating section 620 performs an after-mentioned predetermined calculation (calculations shown in equations (10) to (12) which will be described later), thereby outputting an addition value G, a correction threshold TH, and the luminance threshold P as the predetermined fixed values of the calculated result, to the adding section 621, and the SW sections 623 and 624, respectively. Meanwhile, on the basis of the image signal D0 and the maximum luminance BLmax of each partial lighting section 4, the calculating section 622 performs an after-mentioned predetermined calculation (a calculation shown in equation (13) which will be described later), thereby outputting, for each partial lighting section 4, an image signal D12 of the calculated result to the SW section 623.

As shown in equation (2) below, the adding section 621 generates an image signal D11 by adding the image signal D0 to the addition value G supplied from the calculating section 620, and supplies the added image signal D11 to the SW section 623.

D11=D0+G (2)

The SW section 623 compares the magnitude of the image signal D0 with the magnitude of the correction threshold TH supplied from the calculating section 620. According to the comparative result, the SW section 623 selects one of the image signal D11 supplied from the adding section 621 and the image signal D12 supplied from the calculating section 622, and outputs it as an image signal D13 to the SW section 624. Specifically, in the case where the magnitude of the image signal D0 is equal to or smaller than the correction threshold TH, the SW section 623 selects the image signal D11 so as to output it as the image signal D13. On the other hand, in the case where the magnitude of the image signal D0 is larger than the correction threshold TH, the SW section 623 selects the image signal D12 so as to output it as the image signal D13.

The SW section 624 compares the magnitude of the image signal D0 with the magnitude of the luminance threshold P supplied from the calculating section 620. According to the comparative result, the SW section 624 selects one of the image signal D0 and the image signal D13 supplied from the SW section 623, and outputs it as an image signal D14 to the mixing section 625. Specifically, in the case where the magnitude of the image signal D0 is equal to or smaller than the luminance threshold P, the SW section 624 selects the image signal D13 so as to output it as the image signal D14. On the other hand, in the case where the magnitude of the image signal D0 is larger than the luminance threshold P, the SW section 624 selects the image signal D0 so as to output it as the image signal D14.

On the basis of the value of the flare-countermeasures determined result J1 (for example, in the case where J1 indicates the generation rate of the flare, J1=0 to 100%) supplied from the flare-countermeasures determining section 61, the mixing section 625 outputs the corrected image signal D1 for the flare countermeasures. Specifically, in the case where J=0% (when it is determined according to the flare-countermeasures determined result J1 that there is no risk of generation of the flare phenomenon), the mixing section 625 just outputs the image signal D0 as the image signal D1. On the other hand, in the case where J=100% (when it is determined according to the flare-countermeasures determined result J1 that there is a risk of generation of the flare phenomenon), the mixing section 625 outputs the value of the image signal D14 as the image signal D1. In the case where J=X % (0<x<100), it is expressed as D1={X×D14+(100−X)×D0}/100. In this way, because the mixing section 625 responds to the case where J1 is an intermediate value between 0% and 100%, the image switching is invisible even if the condition with no flare phenomenon is slowly transited to the condition with the flare phenomenon, due to the change of the image signal D0.

Here, the backlight system 1 corresponds to an example of “a light source section” in the present invention, and the image signal input section 60 corresponds to an example of “a signal input section” in the present invention. The backlight control section 12 and the backlight drive section 11 correspond to an example of “a light source driving means” in the present invention. The flare-countermeasures determining section 61, the flare correcting section 62, the dividing section 63, the image memory 64, and the X driver 51 and the Y driver 52 correspond to an example of “a display driving means” in the present invention. The flare-countermeasures determining section 61 corresponds to an example of “a determining means” in the present invention. The flare correcting section 62 and the dividing section 63 correspond to “a correcting means” in the present invention. The image memory 64, and the X driver 51 and the Y driver 52 correspond to an example of “a driving means” in the present invention.

Next, the operation of the liquid crystal display 3 having such a configuration according to the present embodiment will be described in detail.

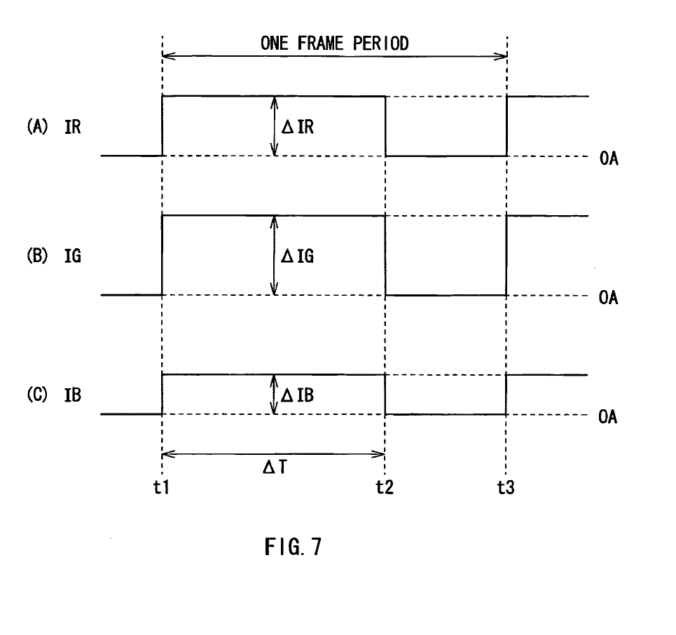

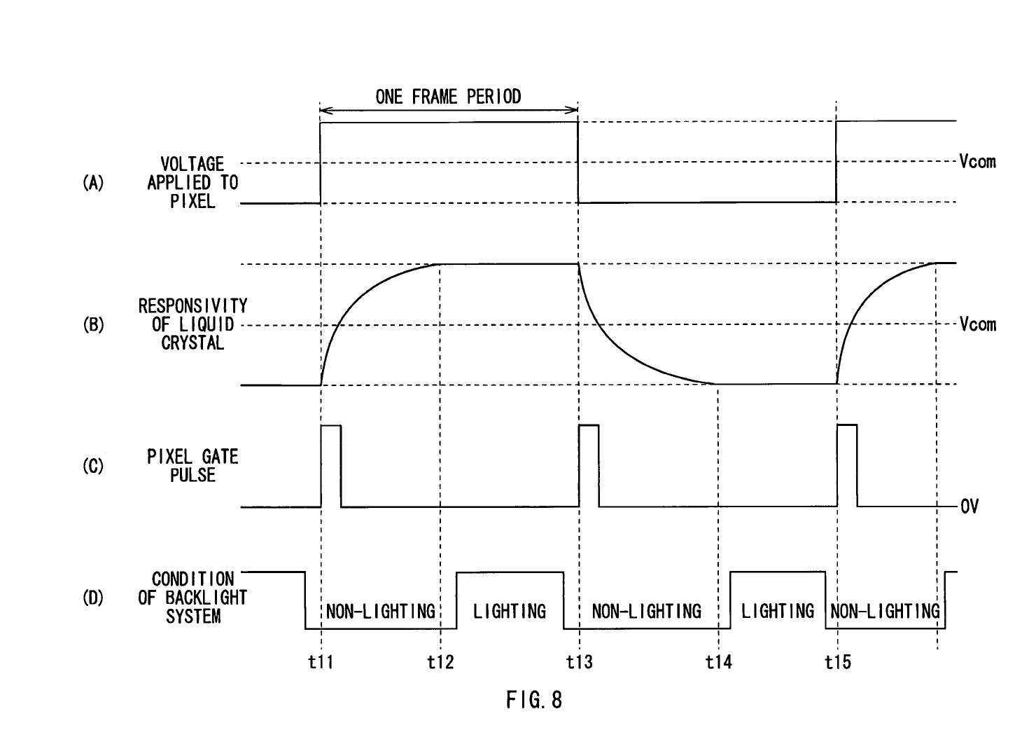

With reference to FIGS. 1, 2A to 2B, 3, 4, 5, 6, 7, and 8, the basic operation of the liquid crystal display 3 according to the present embodiment will be described. FIG. 7 is timing waveform illustrating the lighting operation of the light source section 10 in the backlight system 1. (A) in FIG. 7 shows the current IR flowing through the red LED 1R, (B) in FIG. 7 shows the current IG flowing through the green LED 1G, and (C) in FIG. 7 shows the current IB flowing through the blue LED 1B, respectively. FIG. 8 is timing waveform roughly illustrating the operation of the entire liquid crystal display 3. (A) in FIG. 8 shows voltage (voltage applied to pixels, and drive voltage) applied from the X driver 51 to the pixel electrode 212 in the liquid crystal display panel 2. (B) in FIG. 8 shows responsiveness (the condition of the actual electric potential in the pixel electrode 212) of a liquid crystal molecule. (C) in FIG. 8 shows voltage (a pixel gate pulse) applied from the Y driver 52 to the gate of the TFT element in the liquid crystal display panel 2.

In the backlight system 1, when the switching elements 112R, 112G, and 112B become on-state in the backlight drive section 11, respectively, the currents IR, IG, and IB flow from the constant current drivers 111R, 111G, and 111B to the red LED 1R, the green LED 1G, and the blue LED 1B in the light source section 10, respectively. Thereby, the red light emission, the green light emission, and the blue light emission occur, and the illumination light Lout as the mixed light of these lights is emitted.

At this time, the control signal D3 (the control signal for red D3R, the control signal for green D3G, and the control signal for blue D3B) is supplied from the backlight control section 12 to the backlight drive section 11, and the control signal D6 (the control signal for red D6R, the control signal for green D6G, and the control signal for blue D6B) on the basis of the control signal D3 is supplied from the PWM driver 113 in the backlight drive section 11 to the switching elements 112R, 112G and 112B, respectively. Thereby, the switching elements 112R, 112G, and 112B become on-state at a timing when the control signal D6 is supplied, and the lighting periods of the red LED 1R, the green LED 1G and the blue LED 1B are synchronized to the operation of the switching elements 112R, 112G and 112B. In other words, by separate drive using the control signal D6 as a pulse signal, the red LED 1R, the green LED 1G, and the blue LED 1B are driven in a PWM mode (the red LED 1R, the green LED 1G, and the blue LED 1B are driven so that the lighting periods of these LEDs become variable, respectively).

At this time, the illumination light sensor 13 receives the illumination light Lout from the light source section 10. Specifically, by a photodiode in the illumination light sensor 13, which is not shown in the figure, the illumination light Lout from the light source section 10 is extracted, and the current is generated according to the light intensity of the illumination light Lout. Thereby, the light-receiving data of the current value is supplied to the I/V conversion section 14. The light-receiving data of the current value is converted into the light-receiving data of analogue voltage by the I/V conversion section 14. Then, the light-receiving data of the analogue voltage is sampled in the A/D conversion section 15 at a predetermined timing, and converted in to the light-receiving data D4 of digital voltage.

In the backlight control section 12, on the basis of the light-receiving data D4 supplied from the A/D conversion section 15 and the image signal D0 supplied from the image signal input section 60, the control signals D2R, D2G, and D2B are supplied from the light intensity balance control section 121 to the constant current drivers 111R, 111G, and 111B, respectively. Thereby, AIR, AIG, and AIB which are the magnitudes of the currents IR, IG, and IB, that is, the emitted light luminance (the emitted light intensity) of the LEDs 1R, 1G, and 1B are adjusted so that the luminance and the chromaticity (color balance) of the illumination light Lout are maintained constant (the emitted light intensity of each partial lighting section 4 is maintained constant) (refer to FIGS. 6A to 6C). In the light intensity control section 122, on the basis of the light-receiving data D1 supplied from the AJD conversion section 15 and the image signal D0 supplied from the image signal input section 60, the control signal D3 (the control signal for red D3R, the control signal for green D3G, and the control signal for blue D3B) is generated and supplied to the PWM driver 113. Thereby, the period when the switching elements 112R, 112G, and 112B become on-state, that is, the lighting period ΔT of the LEDs 1R, 1G, and 1B of each color is adjusted (refer to FIGS. 7A to 7C).

In this way, on the basis of the illumination light Lout supplied from the light source section 10, at least one of ΔIR, ΔIG, and ΔIB (the emitted light intensity of the LEDs 1R, 1G, and 1B) as the magnitude of the currents IR, IG, and IB, and the lighting periods of the LEDs 1R, 1G, and 1B is controlled. Thereby, each partial lighting section 4 as a unit is controlled so that the light intensity of the illumination light Lout is maintained constant. On the basis of the image signal D0 (the luminance level of the input image signal) supplied from the image signal input section 60, the light intensity of each partial lighting section 4 is set. Thereby, the contrast of the display image in each partial lighting section 4 as a unit is improved. That is, when the luminance level of the input image signal in a certain partial lighting section 4 is low (when the display image of the partial display region (for example, display regions 41 to 43 which will be described later) corresponding to the certain partial lighting section 4 is dark), the light intensity of that partial lighting section 4 is set to be low. On the other hand, when the luminance level of the input image signal in a certain partial lighting section 4 is high (when the display image of the partial display region corresponding to the certain partial lighting section 4 is bright), the light intensity of that partial lighting section 4 is set to be high.

In the entire liquid crystal display 3 according to the present embodiment, by the drive voltage (the voltage applied to pixels) outputted from the X driver 51 and the Y driver 52 to the pixel electrode 212 on the basis of the image signal D5 stored in the image memory 64, the illumination light Lout from the light source section 10 of the backlight system 1 is modulated in the liquid crystal layer 20, and outputted as the display light Dout from the liquid crystal display panel 2. In this way, the backlight system 1 functions as the backlight (an illumination system for liquid crystal) of the liquid crystal display 3, and thereby the image is displayed by the display light Dout.

Specifically, for example as shown in (C) in FIG. 8, the pixel gate pulse is applied from the Y driver 52 to the gate of the TFT elements of one horizontal line in the liquid crystal display panel 2. Also, as shown in (A) in FIG. 8, the voltage applied to pixels on the basis of the image signal is applied from the X driver 51 to the pixel electrodes 212 of that horizontal line. At this time, as shown in (B) in FIG. 8, the responsivity (the responsivity of the liquid crystal) of the actual electric potential of the pixel electrode 212 to the voltage applied to pixels is delayed (the voltage applied to pixels rises at a timing t11, while the actual electrical potential rises at a timing t12). Thus, in the backlight system 1, the lighting occurs between the timing t12 and a timing t13. This is when the actual electrical potential seems similar to the voltage applied to pixels. Thereby, the image display on the basis of the image signal is performed in the liquid crystal display 3. In FIG. 8, the period between the timing t11 and the timing t13 corresponds to one horizontal period (one frame period). Also, during one succeeding horizontal period between the timing t13 and the timing t15, the operation becomes similar to that of the horizontal period between the timing t11 and the timing t13, except that the voltage applied to pixels is inverted to a common electric potential Vcom for preventing an image-sticking of the liquid crystal.

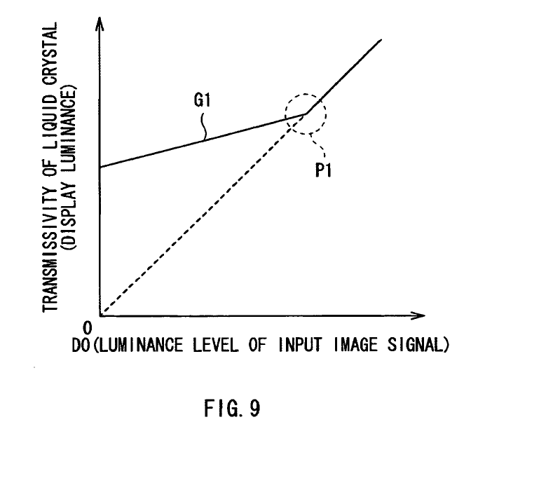

Next, with reference to FIGS. 9, 10A to 10C, 11, 12, 13, 14, 15, 16, 17, and 18 in addition to FIGS. 1, 2A to 2B, 3, 4, 5, 6, 7, and 8, the control operation as the features of the present invention will be described in detail, while comparing with a comparative example.

For example, as shown in FIG. 9, even in the case where the image signal D0 (the luminance level of the input image signal) becomes “0% (zero gradation)”, the transmissivity (display luminance) in the liquid crystal display panel 2 does not become “0%” completely, due to the features of the liquid crystal. That is, when the image signal D0 is located closer to the low-luminance side in comparison with a point P1 in the figure, the light leakage occurs as shown by a straight line G1 in the figure so that it becomes difficult to display the dark area.

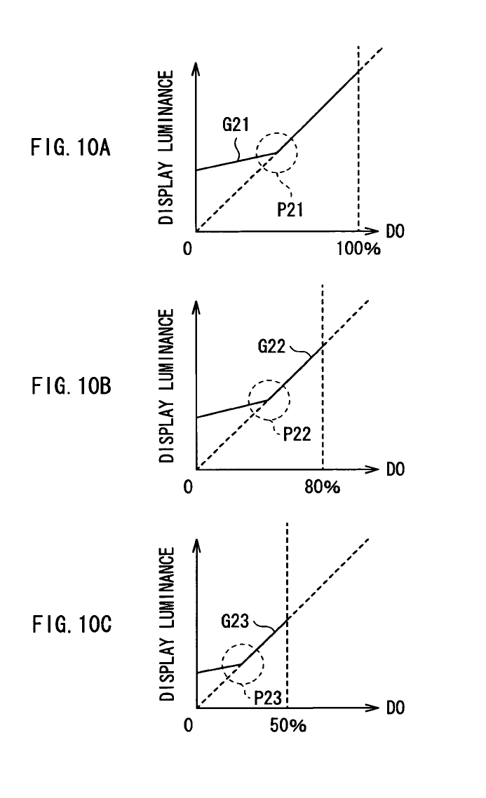

Thus, for example as shown by characteristic lines G21 to G23 in FIGS. 10A to 10C, by changing the luminance of the emitted light from each partial lighting section 4 in the backlight system 1, the light leakage (black color is partially too strong) is suppressed in the low-luminance part as in FIG. 9, and the display of the dark area is achieved. FIG. 10A shows the case where the luminance of the emitted light is 100%, FIG. 10B shows the case where the luminance of the emitted light is 80%, and FIG. 10C shows the case where the luminance of the emitted light is 50%. Thereby, for example as shown in FIG. 1A, when the luminance of the emitted light is 100%, in the case where the minimum display luminance is 10% of the maximum luminance, it is difficult that the display luminance becomes 5% as it is, as shown in equation (3) below. However, by setting the luminance of the emitted light 50% as shown in FIG. 10C, the display luminance becomes 5% as shown in equation (4) below, and thus the display of the dark area is achieved. In addition, by referring to the reference numerals P21 to P23 in FIGS. 10A to 10C, it is understood that, as the luminance of the emitted light from each partial lighting section 4 becomes low, the minimum display luminance and the value of the corresponding image signal D0 become similarly small, and thereby the linearity is used even in the low-luminance side.

BLmax(=100%)×D0(=10%)≠5% (display luminance). (3)

BLmax(=50%)×D0(=10%)=5% (display luminance). (4)

However, because the lighting region in each partial lighting section 4 in the light source section 10 is generally larger than each pixel in the liquid crystal display panel 2, the luminance of the emitted light is set in a region larger than a pixel, actually. Also, because the emitted light itself from each partial lighting section 4 has extensity, it is difficult to control the partial lighting section 4 and the pixel by one to one.

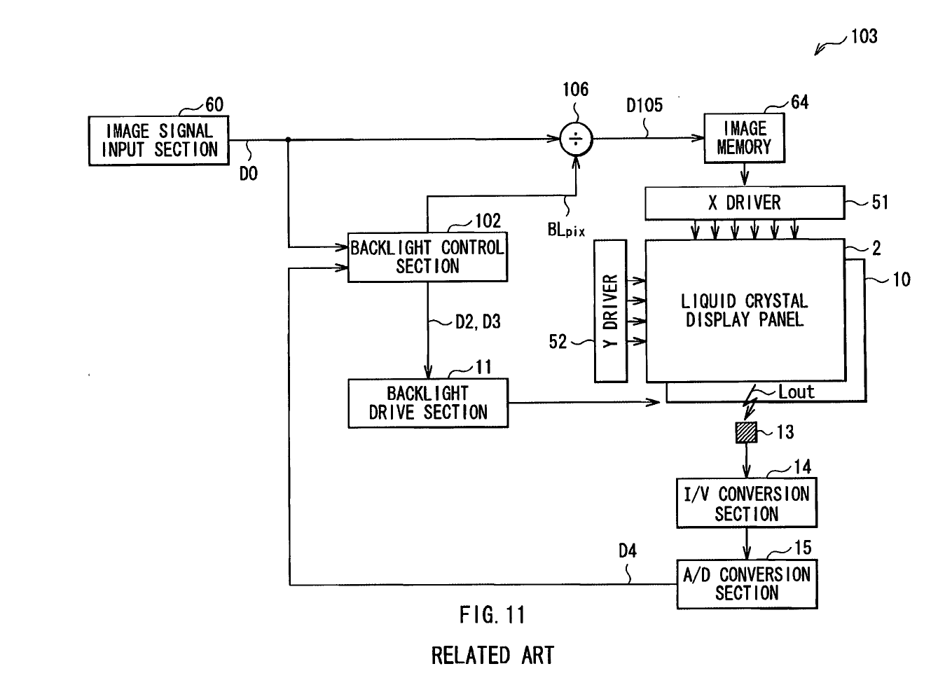

For example, in a liquid crystal display 103 of related art according to a comparative example in FIG. 11, in a backlight control section 102, a control signal D3 is generated on the basis of an image signal D0 supplied from an image signal input section 60, and a luminance (a set luminance BLpix) of the emitted light is set for each partial lighting section 4. After that, in a dividing section 106, the image signal D0 for each pixel, which is supplied from the image signal input section 60, is divided by the set luminance BLpix as in equation (5) below, and thereby an image signal D105 for each pixel, which is supplied to an image memory 64, is generated. Thus, the display may be driven in consideration with the light intensity distribution of the emitted light emitted from each partial lighting section 4. As shown in equation (5), because the value of the image signal D105 becomes large when the set luminance BLpix is low, more liner operation is possible as shown in FIGS. 10A to 10C.

D105=D0/BLpix (5)

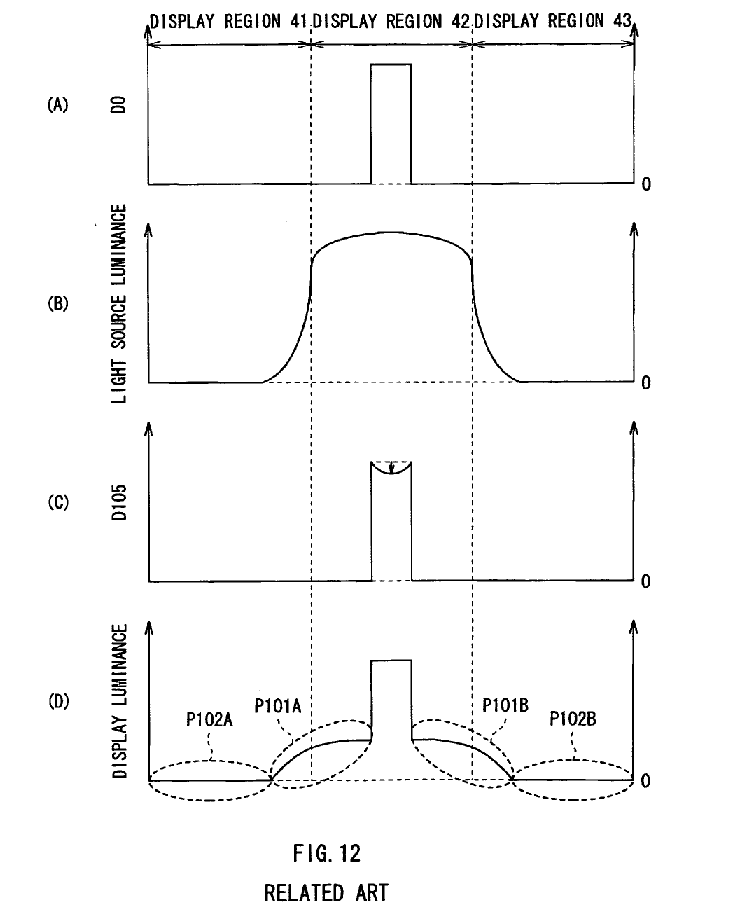

However, in the liquid crystal display 103 according to such a comparative example, for example, as shown in (A) and (B) in FIG. 12, in the case where it is desired that only a few pixel regions in the low-luminance part in the partial display region (display region 42 of display regions 41 to 43) corresponding to the partial lighting section 4 which performs the light operation is displayed brightly, a so-called flare phenomenon occurs. Specifically, the image signal D105 obtained by the dividing process in the dividing section 106 becomes, for example, as shown in (C) in FIG. 12. However, in this case, the luminance (the display luminance) of a display light Dout emitted from a liquid crystal display panel 2 becomes, for example, as shown in (D) in FIG. 12. That is, in the display region 42, the light is emitted to the low-luminance part from the corresponding partial lighting section 4. Because it is difficult that the transmissivity of the liquid crystal display panel 2 becomes “0%” completely, due to the above-mentioned features of the liquid crystal, the light leakage in the low-luminance part occurs, and the black color in the display becomes partially too strong (refer to reference numerals P101A and P101B in (D) in FIG. 12). Therefore, when comparing between the partial display region (the display region 42) partially including the high-luminance part in the low-luminance part, and, for example, the partial display region (for example, the display regions 41 and 43) which is the low-luminance part overall, even if the luminance level (the magnitude of the image signal D0) of the image signal in the low-luminance part of the former partial display region is equal to the luminance level of the image signal in the low-luminance part of the latter partial display region as in (A) in FIG. 12, the display luminances of these low-luminance parts become different from each other as shown by the reference numerals P101A, P101B, P102A, and P102B in (D) in FIG. 12, and the variations of the black displays are visible. When the variations of such display luminance occur, the image quality of the display image is lowered.

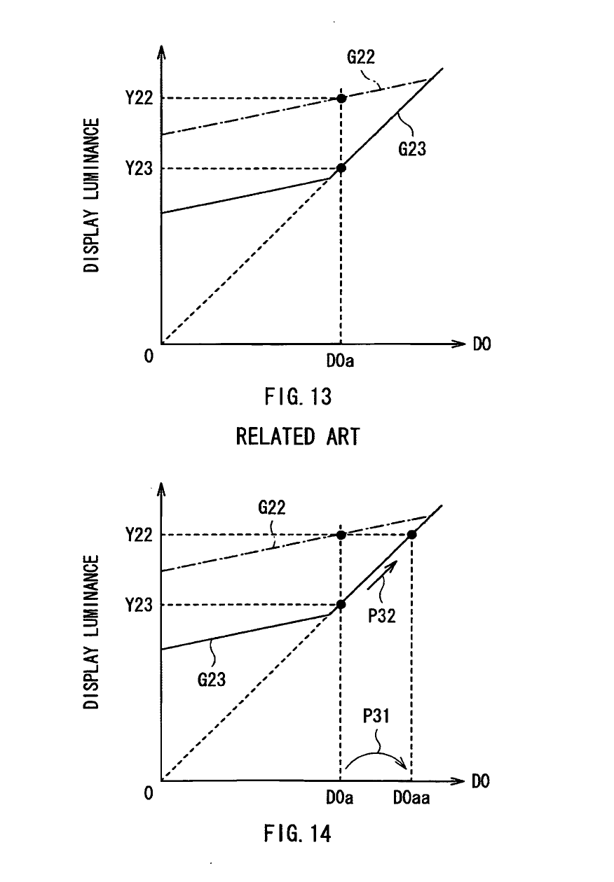

Here, such a flare phenomenon occurs in the case where the luminance level (the magnitude of the image signal D0: for example, a luminance level D0a) of the image signal in the low-luminance part in one partial display region is equal to the luminance level of the image signal in the low-luminance part in another partial display region, for example, as shown in FIG. 13, when comparing between these partial display regions different from each other (for example, the display region 42, and the display regions 41 and 43) have the different set luminances BLpix (for example, the characteristic lines of the reference numerals G22 and G23) of the lighting sections 4, and the luminance level of the image signal in each low-luminance part is set as the luminance level (for example, a luminance level D0a) in a non-linear region. In such a case, like display luminances Y22 and Y23 in the figure, the display luminances of these low-luminance parts become different from each other.

Thus, in the liquid crystal display 3 in the present embodiment, for example, as shown in FIG. 14, when it is determined that there is a risk of generation of the flare phenomenon in the partial display region corresponding to a certain partial lighting section 4, the correction of the image signal D0 in the low-luminance part is performed as follows (for example, the luminance level D0a of the image signal D0 is corrected to the luminance level D0aa) as shown by arrows P31 and P32 in the figure. The correction is performed so that the display luminance in the low-luminance part of the corresponding partial display region becomes approximately equal to the display luminance with a possible maximum light intensity (the maximum luminance BLmax: for example, as shown by the characteristic line G22 in the figure) of the corresponding partial lighting section 4, while maintaining the value of the set luminance BLpix (for example, as shown by the characteristic line G23 in the figure) of the partial lighting section 4 corresponding to the partial display region.

Specifically, as shown in FIG. 4, on the basis of the image signal D0 from the image signal input section 60, the flare-countermeasures determining section 61 determines whether or not there is a risk of generation of “the flare phenomenon” by determining whether or not the predetermined condition is satisfied such that, for example, each partial display region corresponding to the partial lighting section 4 includes the low-luminance part in the periphery of the high-luminance part, the low-luminance part being a display part having the luminance level lower than the predetermined luminance threshold (for example, the luminance threshold P which will be described later) and the high-luminance part being a display part having the luminance level higher than the luminance threshold. The determined result (the flare-countermeasures determined result J1) is outputted to the flare correcting section 62. Next, in the flare correcting section 62, when it is determined according the flare-countermeasures determined result J1 that there is a risk of generation of the flare phenomenon in a certain partial display region, the correction of the image signal D0 in the low-luminance part is performed as follows. If the partial lighting section 4 corresponding to the partial display region is maintained to have the set luminance BLpix, the correction of the image signal D0 in the low-luminance part is performed so that the display luminance in the low-luminance part of the partial display region becomes approximately equal to the display luminance with the maximum light intensity (the max luminance BLmax) of the corresponding partial lighting section 4. Then, the corrected image signal D1 is supplied to the dividing section 63. In the dividing section 63, the image signal D5 is generated by dividing the image signal D1 by the set luminance BLpix of each lighting section 4, and is supplied to the memory 64.

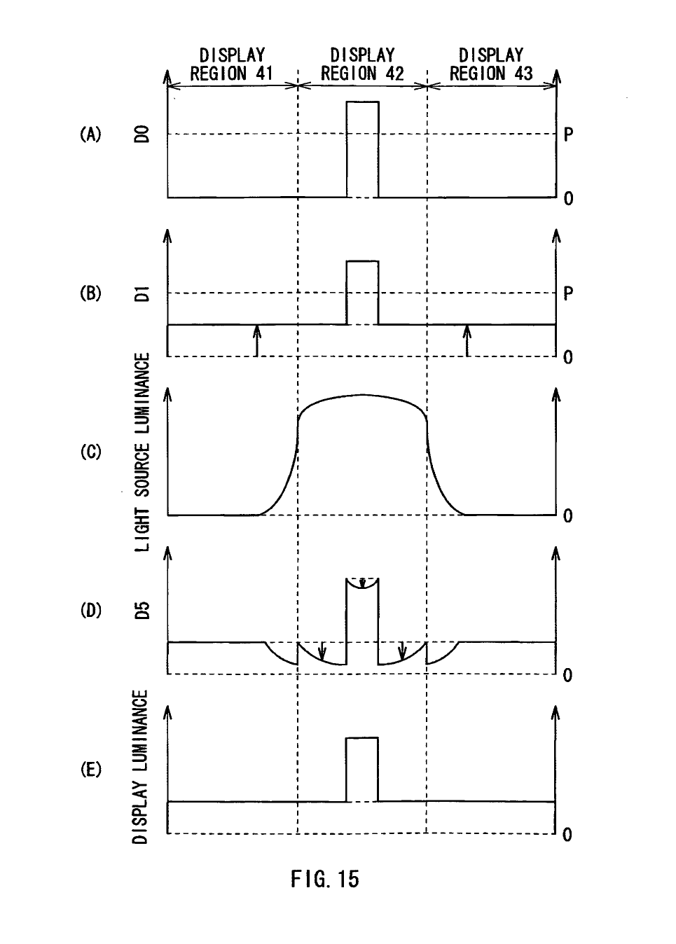

Thereby, for example, as shown in (A) in FIG. 15A, in the case of the partial display region (the display region 42) which partially includes the high-luminance part (the display part having the luminance level higher than that of the luminance threshold P) in the low-luminance part (the display part having the luminance level lower than that of the luminance threshold P), the image signal D0 in the low-luminance part is corrected by the flare correcting section 62, for example, as the image signal D1 in (B) in FIG. 15. Then, for example, as shown in (D) in FIG. 15, the image signal D5 is generated by the dividing section 63. Thus, in the case where the lighting operation is performed in the corresponding partial lighting section 4, for example, as shown in (C) in FIG. 15, when comparing between the display region 42, and the partial display region (the display regions 41 and 43) which is the low-luminance part overall, if the luminance level of the image signal in the low-luminance part of the former partial display region is approximately equal to the luminance level of the image signal in the low-luminance part in the latter partial display region, the display luminances of these low-luminance parts are approximately equal to each other. Thereby, generation of the flare phenomenon is suppressed or prevented, and the variations of the display luminances are suppressed.

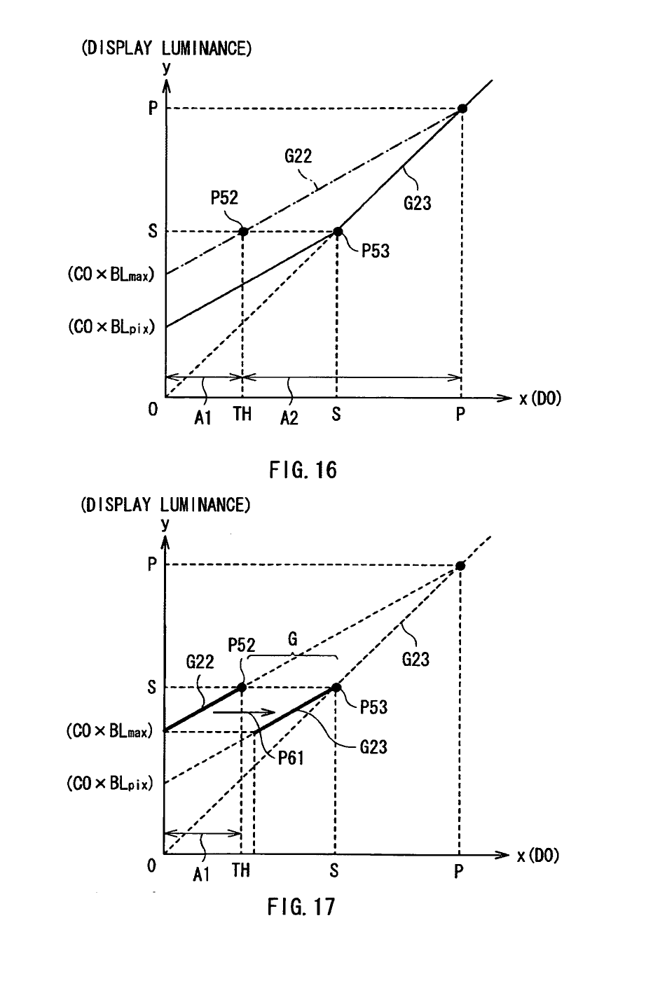

Next, with reference to FIGS. 16 to 18, the process of suppressing the flare phenomenon according to the present embodiment will be described in detail.

The characteristic line G22 in FIG. 16 is expressed as equation (6) below, where the image signal D0 is the X axis, the display luminance is the Y axis, an intercept on the Y axis when the set luminance of the partial lighting section 4 is 100% is C0, and the gradient of the characteristic line G22 (a characteristic line of the maximum luminance BLmax) in the luminance part having the luminance equal to or lower than the luminance threshold P is α. Because a luminance S of a switching point P53 of the gradient of the straight line of the characteristic line G23 (a characteristic line of the set luminance BLpix) is a value of an interacting point of equation (7) and equation (8) below, the luminance S is expressed as equation (9) below. Because the luminance level TH (the correction threshold TH) of the image signal D0 is an X value on the point 52 in the figure, by substituting y=S in equation (6) below, the luminance level TH is expressed as equation (10) below. In addition, because the threshold luminance P is a value of an intersecting point of equation (6) and equation (8) below, the threshold luminance P is expressed as equation (11) below.

y=α×x+(C0×BLmax). (6)

y=α×x+(C0×BLpix). (7)

y=x (8)

S=(C0×BLpix)/(1−α). (9)

TH=(C0/α)×[{BLpix/(1−α)}−BLmax] (10)

P=(C0×BLmax)/(1−α). (11)

Here in the present embodiment, for example, as shown in FIG. 6, the correction process of the image signal D0 by the flare correcting section 62 is varied according to whether or not the value of the image signal D0 is larger than the correction threshold TH (as shown in FIG. 16, it depends on whether the value of the image signal D0 is in a luminance range A1 or a luminance range A2). The correction process of such an image signal D0 is performed when the value of the image signal D0 is equal to or smaller than the luminance threshold P.

Specifically, in the case where the value of the image signal D0 is equal to or smaller than correction threshold TH (when the value of the image signal D0 is in the luminance range A1), for example, as shown by an arrow P61 in FIG. 17, in the flare correcting section 62, a predetermined constant value G expressed by equation (12) below is added to the inputted image signal D0, and thereby the correction of the image signal D0 in the low-luminance part is performed. More specifically, in the SW section 623 in the flare correcting section 62 in FIG. 6, the corrected image signal D11 by the calculating section 620 and the adding section 621 is selected and outputted as the image signal D13.

$$\begin{matrix}G = ( S - TH ) \\ = \{ ( C 0 \times BLpix ) / ( 1 - α ) \} - \\ ( C 0 / α ) \times [ \{ BLpix / ( 1 - α ) \} - BLmax ]\end{matrix} \qquad ( 12 )$$

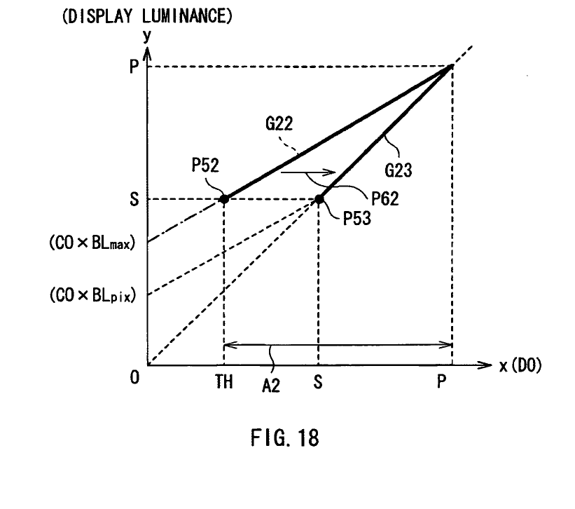

On the other hand, in the case where the value of the image signal D0 is larger than the correction threshold TH (when the value of the image signal D0 is in the luminance range A2), for example, as shown by an arrow P62 in FIG. 18, in the flare correcting section 62, a variable value according to the luminance level of the image signal D0 is added to the inputted image signal D0, and thereby the correction of the image signal D0 in the low-luminance part is performed as expressed by equation (13) below. More specifically, in the SW section 623 in the flare correcting section 62 in FIG. 6, the corrected image signal D12 by the calculating section 622 is selected and outputted as the image signal D13.

x′=α×x+(C0×BLmax). (13)

In this way, in the present embodiment, on the basis of the image signal D0 inputted from the image signal input section 60, when it is determined by the flare-countermeasures determining section 61 that the predetermined condition is satisfied such that the partial display region corresponding to the partial lighting section 4 includes the low-luminance part in the periphery of the high-luminance part, the low-luminance part being a display part having the luminance level lower than the luminance threshold P and the high-luminance part being a display part having the luminance level higher than the predetermined luminance threshold P, the correction of the image signal D0 in the low-luminance part is performed as follows by the flare correcting section 62. If the partial lighting section 4 corresponding to the partial display region satisfying the above-mentioned predetermined condition has the light intensity (the set luminance BLpix) set by the backlight control section 12, the correction of the image signal D0 in the low-luminance part is performed so that the display luminance of the low-luminance part in the partial display region becomes approximately equal to the display luminance with the maximum light intensity (the maximum luminance BLmax) of the corresponding partial lighting section 4. Then, the display in the low-luminance part is driven on the basis of the corrected image signal D1. Therefore, when comparing between the partial display region (for example, the display region 42) partially including the high-luminance part in the low-luminance part, and, for example, the partial display region (for example, the display regions 41 and 43) which is the low-luminance part overall, in the case where the luminance level of the image signal D0 in the low-luminance part in the former partial display region is approximately equal to the luminance level of the image signal D0 in the low-luminance part in the latter partial display region, the display luminances of these low-luminance parts are approximately equal to each other, and thereby variations of the display luminances are suppressed. Therefore, in the case where the lighting operation is performed by the backlight system 1, the image quality of the display image may be improved.

### Modification

Next, a modification of the present invention will be described. Same reference numerals as in the above embodiment have been used to indicate substantially identical components, and thereby the description is appropriately omitted.

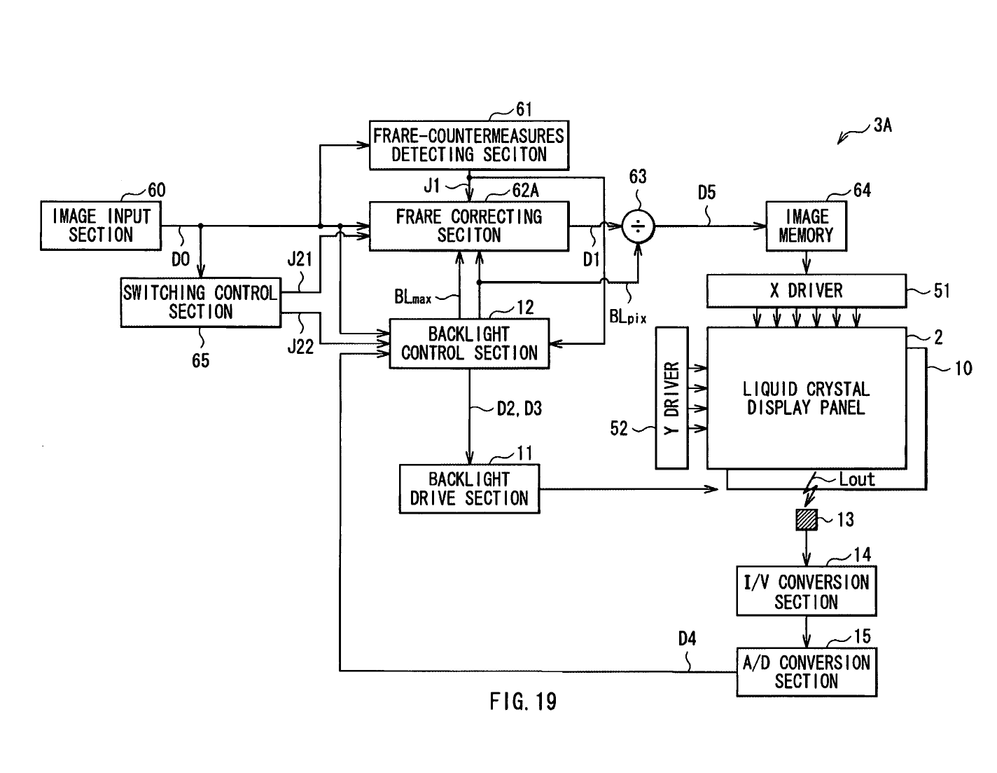

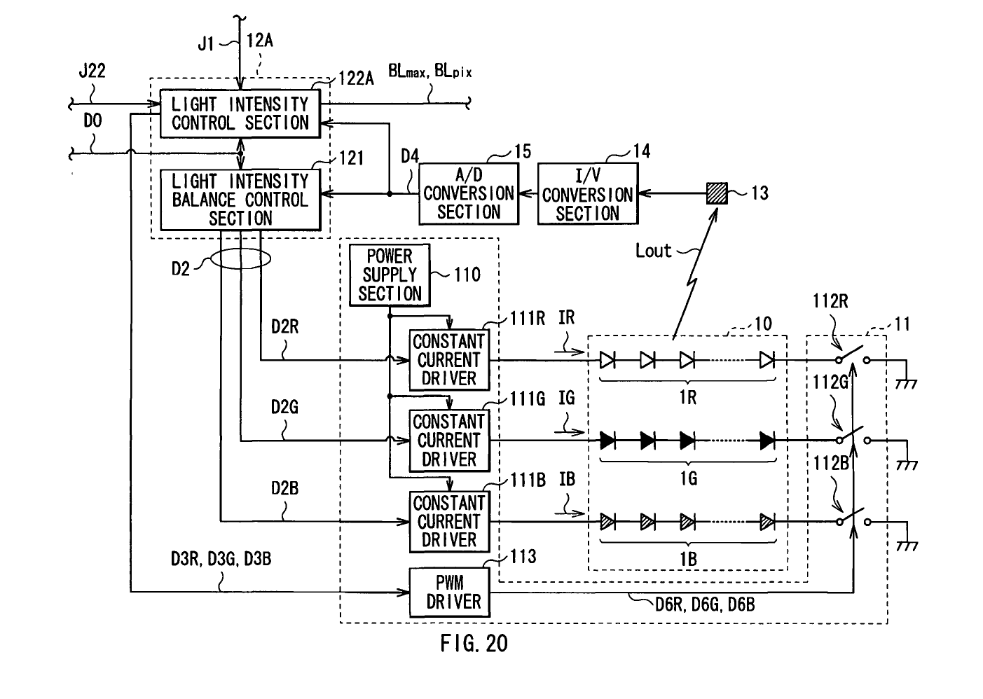

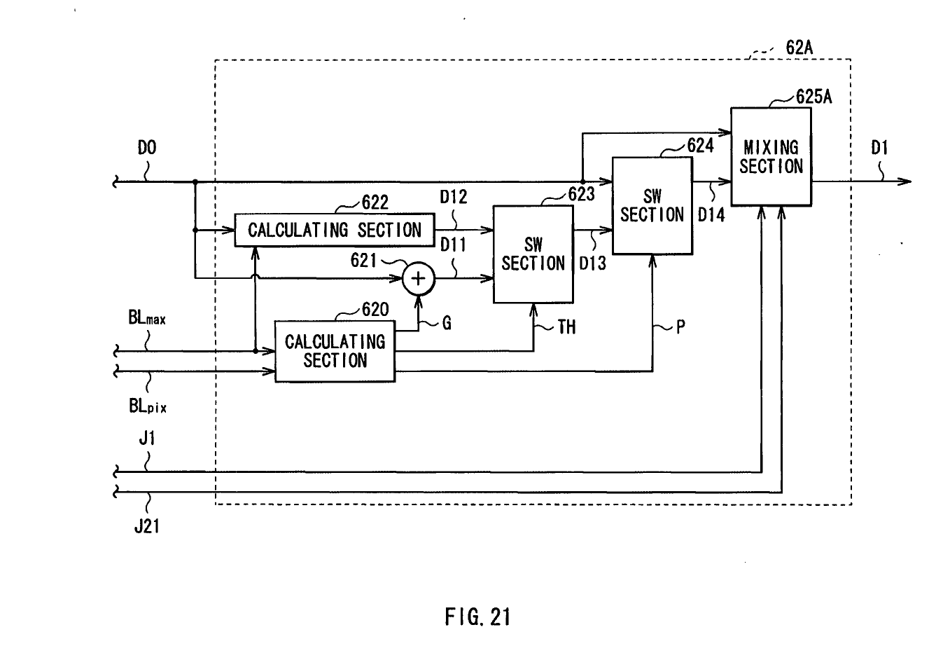

FIG. 19 is a block diagram illustrating a liquid crystal display (a liquid crystal display 3A) according to a modification of the present invention. The liquid crystal display 3A includes a backlight control section 12A and a flare correcting section 62A instead of the backlight control section 12 and the flare correcting section 62 in the liquid crystal display 3 of the embodiment, and additionally includes a switching control section 65. FIG. 20 is a block diagram illustrating detail of the backlight control section 12A. FIG. 21 is a block diagram illustrating detail of the flare correcting section 62A. A liquid crystal display module according to the modification of the present invention and a method of driving the liquid crystal display according to the modification of the present invention are realized by the liquid crystal display of the present modification, and thus they will also be described in addition.

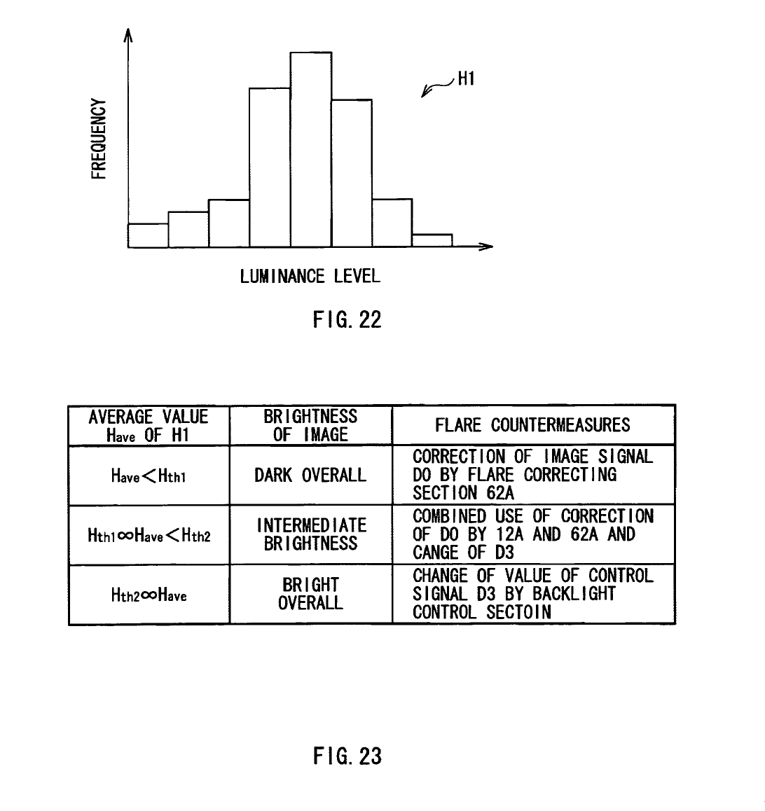

The switching control section 65 produces a luminance histogram distribution H1, for example, as shown in FIG. 22, on the basis of an image signal D0 inputted from an image signal input section 60. The switching control section 65 performs switching control of flare countermeasures, for example, as shown in FIG. 23 by using the produced luminance histogram distribution H1 (for example, according to the magnitude of the average value Have of the luminance histogram distribution H1). In addition, such a switching control is performed by outputting switching determined results J21 and J22 to a mixing section 625A in the flare correcting section 62A, and a light intensity control section 122A in a backlight control section 12A, respectively.

That is, in the case where the average value Have of the luminance histogram distribution H1 is smaller than a predetermined luminance threshold Hth1 (Have<Hth1) (when the image is dark overall), the correction of the image signal D0 is performed by a flare-countermeasures determining section 61, the flare correcting section 62A, and a dividing section 63, as described in the embodiment. Then, the display of the low-luminance part is driven on the basis of the corrected image signal D1 (the image signal D5), and thereby the flare countermeasures are taken.

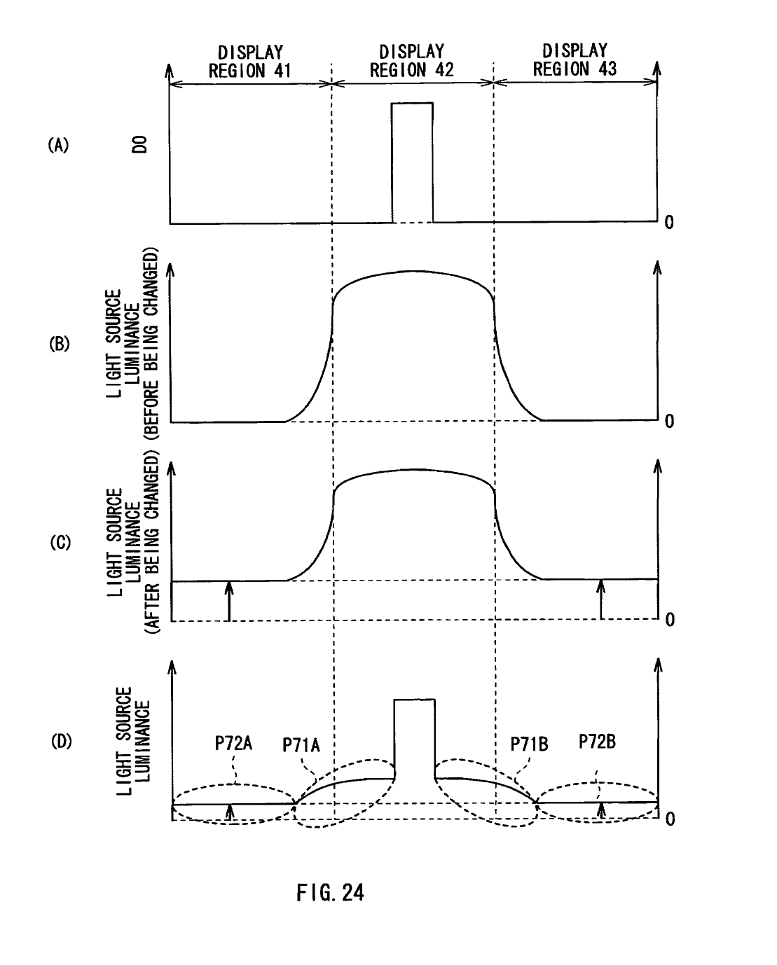

On the other hand, in the case where the average value Have of the luminance histogram distribution H1 is equal to or larger than a predetermined luminance threshold Hth2 (>luminance threshold Hth1) (Hth2<Have) (when the image is bright overall), by the flare-countermeasures determining section 61 and the backlight control section 12A, the lighting is driven (the value of the control signal D3 is changed to be larger than the light intensity (the set luminance BLpix) set on the basis of the inputted image signal D0) on the basis of the control signal D3 with which the light intensity of the partial lighting section increases. Thereby, the flare countermeasures are taken. Thus, for example, as shown in (A) and (B) in FIG. 24, in the case of the image signal D0 and the light source luminance (before being corrected) being likely determined as there is a risk of generation of the flare phenomenon, and the light source luminance (before being corrected) in the display region 42, by changing the value of the control signal D3 so as to increase the light source luminance, the partial lighting section 4 corresponding to the display region 42 has the light source intensity (after being corrected) as shown, for example, in (C) in FIG. 24. Therefore, for example, as shown by the reference numerals P71A, P72A, P71B, and P72B in (D) in FIG. 24, when comparing between the partial display region (for example, the display region 42) partially including the high-luminance part in the low-luminance part, and the partial display region (for example, the display regions 41 and 43) which is the low-luminance part overall, for example, in the case where the luminance level of the image signal D0 in the low-luminance part in the former partial display region is approximately equal to the luminance level of the image signal D0 in the low-luminance part in the latter partial display region, the display luminances of these low-luminance parts are approximately equal to each other. Thereby generation of the flare phenomenon is suppressed or prevented.

In the case where the average value Have of the luminance histogram distribution H1 is equal to or larger than the luminance threshold Hth1 and smaller than the luminance threshold Hth2 (Hth1<Have<Hth2) (when the image is intermediate between dark and bright), by the flare-countermeasures determining section 61, the backlight control section 12A, the flare correcting section 62A, and the dividing section 63, the display in the low-luminance part is driven on the basis of the corrected image signal D1 (the image signal D5), and, at the same time, the lighting is driven according to the control signal D3 so as to increase the light intensity of the partial lighting section 4. Thereby, the flare countermeasures are taken.

In the present modification, provided is the switching control section 65 which controls the switching for performing at least one of the operations, driving the display in the low-luminance part on the basis of the corrected image signal D1 (the image signal D5), or driving the lighting, on the basis of the control signal D3, so as to increase the light intensity of the partial lighting section 4. Thus, for example, appropriate countermeasures for the flare phenomenon may be taken according to the brightness of the display image or the like. Therefore, in the case where the lighting operation is performed by the backlight system 1, the image quality of the display image may be improved.

The switching control section 65 performs the above-mentioned switching control by using the luminance histogram distribution H1 in the partial lighting section 4, the luminance histogram distribution formed on the basis of the image signal D0 inputted from the image signal input section 60. Thus, the switching control may be performed in easy way.

In the present modification, the case is explained where three types of countermeasures for the flare phenomenon are switched according to the magnitude of the average value Have of the luminance histogram distribution H1. However, it is not limited to such a switching control. For example, it is also possible that the display in the low-luminance part is driven according to the corrected image signal D1 (the image signal D5) and at the same time, the lighting is driven on the basis of the control signal D3 so as to increase the light intensity of the partial lighting section 4, and the ratio of these two types of countermeasures for the flare phenomenon is changed with each other according to the magnitude of the average value Have of the luminance histogram distribution H1.

Hereinbefore, the present invention is described with the embodiment and the modification. However, the present invention is not limited to these, and various modifications are available.

For example, in the embodiment, the case is explained where the correction threshold TH and the luminance threshold P are the fixed values. However, for example, these thresholds may be freely adjusted by uses with menu screens or the like.

In the embodiment, the case is explained where the maximum luminance BLmax is the possible maximum luminance for each partial lighting section 4 (the case where the value is arbitrary). However, the maximum luminance BLmax may be the fixed value, as BLmax=100%.

In the embodiment, as shown in FIGS. 4 and 9, the case is explained where the correction for the flare countermeasures is performed in a previous stage of the dividing section 63. However, for example, it is also possible that, by disposing the flare-countermeasures determining section 61, the flare correcting section 62, and the backlight control section 12 in a subsequent stage of the dividing section 63, respectively, the correction for the flare countermeasures is performed in the subsequent stage of the dividing section 63. In the case of such a configuration, the similar effects to the embodiment may be obtained.

In the embodiment, the case is explained where the light source section 10 includes the red LEDs 1R, the green LEDs 1G, and the blue LEDs 1B. In addition to these LEDs (or instead of these LEDs), the light source section 10 may include LEDs emitting other color lights. For example, in the case where the light source section 10 includes LEDs of four colors or more, the color reproduction range becomes larger, and the display with more various colors may be possible.

In the embodiment, the case is explained where the light source section 10 includes a plurality of red LEDs 1R, a plurality of green LEDs 1G, and a plurality of blue LEDs 1B, and the backlight system 1 is an additive color mixing backlight system obtaining the illumination light Lout as a specific color light (white light) by mixing a plurality of color lights (a red light, a green light, and a blue light). However, the light source section may include only LEDs of a single color, and the backlight system emits the illumination light of the single color.

Further, in the embodiment, the case is explained where the liquid crystal display 3 is a transmissive liquid crystal display including the backlight system 1 as a light source section. However, for example, the light source section may include a front light system, and thus the liquid crystal display may be a reflective liquid crystal display.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display comprising:
a signal input section through which an image signal from external is inputted;
a light source section including a plurality of partial lighting sections to be controlled independently of one another;
a light source driving means for determining a light intensity of each partial lighting section according to the image signal inputted from the signal input section, and driving the light source section so that each partial lighting section is independently activated with the light intensity determined;
a liquid crystal display panel including a plurality of pixels which are arranged in a matrix form, and displaying an image by modulating light emitted from the light source section for each pixel; and
a display driving means for driving the liquid crystal display panel based on the image signal inputted through the signal input section,
wherein, in a case that a partial display region corresponding to a partial lighting section includes a high-luminance part with a luminance level higher than a luminance threshold and a low-luminance part with a luminance level lower than the luminance threshold, the low-luminance part surrounding the high-luminance part, the display driving means corrects the image signal in the low-luminance part so that the display luminance level in the low-luminance part results in the same level as the display luminance level under a maximum light intensity of the corresponding partial lighting section, and drives pixels in the low-luminance part according to the image signal corrected.

2. The liquid crystal display according to claim 1, wherein the display driving means corrects the image signal in the low-luminance part by adding a predetermined constant value to the inputted image signal, when luminance level of the inputted image signal is in a first luminance range where the luminance level is equal to or smaller than a predetermined correction threshold, the first luminance range being prescribed in luminance characteristics which is a relationship between the image signal in the low-luminance part and the corresponding display luminance.

3. The liquid crystal display according to claim 1, wherein the display driving means corrects the image signal in the low-luminance part by adding a variable value to the inputted image signal, the variable value depending on the luminance level of the inputted image signal, when the luminance level of the inputted image signal is in a second luminance range where the luminance level is larger than the predetermined correction threshold, the first luminance range being prescribed in luminance characteristics which is a relationship between the image signal in the low-luminance part and the corresponding display luminance.

4. The liquid crystal display according to claim 1, wherein the display driving means comprising:
a determining means for determining, based on the inputted image signal, whether or not the partial display region includes the low-luminance part around the high-luminance part;
a correcting means for correcting the image signal in the low-luminance part so that the display luminance level in the low-luminance part results in the same level as a display luminance level under a maximum light intensity of the corresponding partial lighting section, in the case where the determining means determines that the partial display region includes the low-luminance part around the high-luminance part; and
a driving means for driving pixels in the low-luminance part according to the image signal corrected.

5. The liquid crystal display according to claim 4, wherein the determining means determines whether or not the partial display region includes the low-luminance part around the high-luminance part, in consideration of whether or not the low-luminance part extends so as to surround the high-luminance part.

6. The liquid crystal display according to claim 1, wherein the display driving means drives pixels in the low-luminance part according to the image signal corrected in consideration of a light intensity distribution of light emitted from the partial lighting section.

7. The liquid crystal display according to claim 1, wherein the light source driving means drives lighting so that light intensity of the partial lighting sections corresponding to adjacent partial display regions increase larger than the light intensity determined according to the inputted image signal.

8. The liquid crystal display according to claim 7, further comprising a switching means for controlling switching between a first driving step by the display driving means and a second driving step by the light source driving means so that at least one of the two steps is executed, where the first driving step is a step of driving pixels in the low-luminance region according to the image signal corrected, and the second driving step is a step of driving the lighting so that light intensity of the partial lighting sections corresponding to adjacent partial display regions increase larger than the light intensity determined according to the inputted image signal.

9. The liquid crystal display according to claim 8, wherein the switching means controls the switching through use of a luminance histogram distribution in the partial display region, the luminance histogram distribution being formed according to the inputted image signal.

10. A liquid crystal module applied to a liquid crystal display comprising:
a light source section including a plurality of partial lighting sections to be controlled independently of one another;
a light source driving means for determining a light intensity of each partial lighting section according to an image signal from external, and driving the light source section so that each partial lighting section is independently activated with the light intensity determined;
a liquid crystal display panel including a plurality of pixels which are arranged in a matrix form, and displaying an image by modulating light emitted from the light source section for each pixel; and
a display driving means for driving the liquid crystal display panel based on the image signal,
wherein, in a case that a partial display region corresponding to a partial lighting section includes a high-luminance part with a luminance level higher than a luminance threshold and a low-luminance part with a luminance level lower than the luminance threshold, the low-luminance part surrounding the high-luminance part, the display driving means corrects the image signal in the low-luminance part so that the display luminance level in the low-luminance part results in the same level as the display luminance level under a maximum light intensity of the corresponding partial lighting section, and drives pixels in the low-luminance part according to the image signal corrected.

11. A liquid crystal display module applied to a liquid crystal display which includes a light source section having a plurality of partial lighting sections to be controlled independently of one another comprising:
a light source driving means for determining a light intensity of each partial lighting section according to an external image signal from external, and driving the light source section so that each partial lighting section is independently activated with the light intensity determined;
a liquid crystal display panel including a plurality of pixels which are arranged in a matrix form, and displaying an image by modulating light emitted from the light source section for each pixel; and
a display driving means for driving the liquid crystal display panel based on the image signal,
wherein, in a case that a partial display region corresponding to a partial lighting section includes a high-luminance part with a luminance level higher than a luminance threshold and a low-luminance part with a luminance level lower than the luminance threshold, the low-luminance part surrounding the high-luminance part, the display driving means corrects the image signal in the low-luminance part so that the display luminance level in the low-luminance part results in the same level as the display luminance level under a maximum light intensity of the corresponding partial lighting section, and drives pixels in the low-luminance part according to the image signal corrected.

12. A method of driving a liquid crystal display having a light source section including a plurality of partial lighting sections to be controlled independently of one another; and a liquid crystal display panel including a plurality of pixels which are arranged in a matrix form and displaying an image by modulating light emitted from the light source section for each pixel,
the method comprising:
determining a light intensity of each partial lighting section according to an image signal inputted from external,
driving the light source section so that each partial lighting section is independently activated with the light intensity determined, and
driving the liquid crystal display panel based on the inputted image signal,
wherein, in a case that a partial display region corresponding to a partial lighting section includes a high-luminance part with a luminance level higher than a luminance threshold and a low-luminance part with a luminance level lower than the luminance threshold, the low-luminance part surrounding the high-luminance part, the image signal in the low-luminance part is corrected so that the display luminance level in the low-luminance part results in the same level as the display luminance level under a maximum light intensity of the corresponding partial lighting section, and pixels in the low-luminance part are driven according to the image signal corrected

13. A liquid crystal display comprising:
a signal input section through which an image signal from external is inputted;
a light source section including a plurality of partial lighting sections to be controlled independently of one another;
a light source driving section determining a light intensity of each partial lighting section according to the image signal inputted from the signal input section, and driving the light source section so that each partial lighting section is independently activated with the light intensity determined;
a liquid crystal display panel including a plurality of pixels which are arranged in a matrix form, and displaying an image by modulating light emitted from the light source section for each pixel; and
a display driving section driving the liquid crystal display panel based on the image signal inputted through the signal input section,
wherein, in a case that a partial display region corresponding to a partial lighting section includes a high-luminance part with a luminance level higher than a luminance threshold and a low-luminance part with a luminance level lower than the luminance threshold, the low-luminance part surrounding the high-luminance part, the display driving section corrects the image signal in the low-luminance part so that the display luminance level in the low-luminance part results in the same level as the display luminance level under a maximum light intensity of the corresponding partial lighting section, and drives pixels in the low-luminance part according to the image signal corrected.

14. A liquid crystal module applied to a liquid crystal display comprising:
a light source section including a plurality of partial lighting sections to be controlled independently of one another;
a light source driving section determining a light intensity of each partial lighting section according to an image signal from external, and driving the light source section so that each partial lighting section is independently activated with the light intensity determined;
a liquid crystal display panel including a plurality of pixels which are arranged in a matrix form, and displaying an image by modulating light emitted from the light source section for each pixel; and
a display driving section driving the liquid crystal display panel based on the image signal,
wherein, in a case that a partial display region corresponding to the partial lighting section includes a high-luminance part with a luminance level higher than a luminance threshold and a low-luminance part with a luminance level lower than the luminance threshold, the low-luminance part surrounding the high-luminance part, the display driving section corrects the image signal in the low-luminance part so that the display luminance level in the low-luminance part results in the same level as the display luminance level under a maximum light intensity of the corresponding partial lighting section, and drives pixels in the low-luminance part according to the image signal corrected.

15. A liquid crystal display module applied to a liquid crystal display which includes a light source section having a plurality of partial lighting sections to be controlled independently of one another comprising:
a light source driving section determining a light intensity of each partial lighting section according to an external image signal from external, and driving the light source section so that each partial lighting section is independently activated with the light intensity determined;
a liquid crystal display panel including a plurality of pixels which are arranged in a matrix form, and displaying an image by modulating light emitted from the light source section for each pixel; and
a display driving section driving the liquid crystal display panel based on the image signal,
wherein, in a case that a partial display region corresponding to the partial lighting section includes a high-luminance part with a luminance level higher than a luminance threshold and a low-luminance part with a luminance level lower than the luminance threshold, the low-luminance part surrounding the high-luminance part, the display driving section corrects the image signal in the low-luminance part so that the display luminance level in the low-luminance part results in the same level as the display luminance level under a maximum light intensity of the corresponding partial lighting section, and drives pixels in the low-luminance part according to the image signal corrected.
